(19) United States
(12) Patent Application Publication
(10) Pub. No.: US 2025/0192712 A1
(43) Pub. Date: Jun. 12, 2025

(54) RELIEF OF HIGHER-LOADED SWITCHING ELEMENTS IN TRACTION INVERTERS BY MEANS OF DUTY CYCLE ADAPTATION

(71) Applicant: Vitesco Technologies GmbH, Regensburg (DE)

(72) Inventors: Thomas ZIEGLMEIER, Regensburg (DE); Sebastian KOWARSCHIK, Regensburg (DE); Josef LAUMER, Haselbach (DE); Manuel ZITZLER, Schwandorf (DE)

(73) Assignee: Vitesco Technologies GmbH, Regensburg (DE)

(21) Appl. No.: 18/845,584

(22) PCT Filed: Mar. 15, 2023
(86) PCT No.: PCT/EP2023/056572

§ 371 Date: Sep. 10, 2024

(30) Foreign Application Priority Data
Mar. 17, 2022 (DE) 10 2022 202 658.6

(51) Int. Cl. H02P 27/08; H02M 1/00; H02M 1/32; H02M 7/5387; H02P 29/68

(52) U.S. Cl. CPC H02P 27/085; H02M 1/327; H02M 7/5387; H02P 29/68; H02M 1/0054

(57) ABSTRACT

A method for controlling a multi-phase traction inverter having the following steps is described. It is determined whether the condition that an electrical frequency of the output signal of the traction inverter is below a predefined limit is met. If the condition is met, that phase of the traction inverter which carries the highest current load among all the phases of the traction inverter is ascertained. A duty cycle offset of this phase with respect to a duty cycle of 50% is ascertained. The duty cycle offset of this phase is then changed by changing the duty cycle of this phase by a duty cycle change. Finally, the duty cycles of the other phases of the traction inverter are adapted by also changing their duty cycles by the duty cycle change. Furthermore, a traction inverter having a control unit which implements the method is described.

### CROSS REFERENCE TO RELATED APPLICATIONS

This application is the U.S. National Phase Application of PCT International Application No. PCT/EP2023/056572, filed Mar. 15, 2023, which claims priority to German Patent Application No. 10 2022 202 658.6, Mar. 17, 2022, the contents of such applications being incorporated by reference herein.

### BACKGROUND OF THE INVENTION

Electric powered vehicles have a traction inverter which supplies power to an electric machine connected thereto and that is used for traction. In this case, the traction inverter generates, by means of a plurality of half bridges by way of clocked switching of these half bridges, a (multi-phase) three-phase current which leads to the generation of a magnetic rotating field in the electric machine.

Due to the powers of more than 100 kW used in this case, the switching elements used in the traction inverter are exposed to a high thermal load. In particular during slow driving and especially at high torques, which can occur when slowly driving up steps (for instance a curb), individual switching elements of the traction inverter are subjected to a higher load than other switching elements of the traction inverter. Designing all the switching elements for such high individual loads would be inefficient and would lead to high costs and so it is an aim of the invention to present a possibility with which the high thermal load of individual switching elements can be reduced.

### SUMMARY OF THE INVENTION

It is proposed to relieve that phase of a traction inverter which carries the highest (one-sided) current load, in particular at low speeds, by shifting the duty cycle in the direction of 50%. In particular, the duty cycle of the phase which has the transistor with the highest current load is shifted in the direction of a duty cycle of 50%. This relates in particular to the phase or the transistor which carries the highest current load on average (over a predefined duration).

The individual phases of the traction inverter each have a half bridge which has a high-side transistor and a low-side transistor. Especially during slow journeys, the high-side transistor (or the low-side transistor) can, for a relatively long duration, be subjected to considerably higher loads than the other transistor of the same half bridge. Shifting the duty cycle in the direction of 50% reduces this high thermal load on the individual high-side or low-side transistor. In order to maintain the rotating field, the other phases of the transistor are also controlled with correspondingly adapted duty cycles.

A corresponding multi-phase traction inverter has, for each phase, a half bridge with a high-side transistor and a low-side transistor connected in series. The high-side transistor has one end (in the power path) which is connected to a positive DC power supply potential and the low-side transistor has one end (in the power path) which is connected to a negative DC power supply potential. The half bridge extends between these two potentials. The two transistors of the half bridge are linked via a connection point which forms the phase connection for the electric machine. The two transistors of each half bridge each have a further end (in the power path), wherein these ends of the two transistors are connected to each other at the connection point.

At very slow speed and at high demanded torque, one phase can be controlled with a duty cycle which differs greatly from 50%, wherein one of the two transistors of the phase is then switched on and carries the current considerably more than 50% of the period duration. This amount of time is reduced by the shifting according to the invention so that the torque generation is distributed more evenly to all the transistors, in particular also more evenly to the two transistors of that half bridge which carries the highest current load. Adapting the duty cycles of the other phases ensures continuous generation of a torque.

Therefore, a method for controlling a multi-phase traction inverter of a motor vehicle having the following steps is described. Firstly, it is determined whether an electrical frequency of the output signal of the traction inverter is below a predefined limit. This electrical frequency indicates the speed of the electric machine or the electrical speed of the three-phase current output by the traction inverter. The predefined limit reflects a speed or driving speed below which one of the transistors warms up significantly more than the other transistors at a duty cycle considerably different from 50%. The predefined limit in this case corresponds to a temperature distribution or an expected temperature distribution of the transistors, in which the most heavily loaded transistor generates a power loss that is increased by more than 10%, 25% or 50% (compared to the average of all the transistor temperatures or compared to a temperature of another transistor) for a minimum duration which, for example, may be more than 5 ms, 10 ms or 50 ms. Depending on the type of transistor, shorter durations are also possible in this case, for instance 100 μs, 200 μs or 500 μs. Within this duration, no switching operation takes place for the most heavily loaded transistor in question but the latter is switched on continuously so that a hotspot can form within the traction inverter on this switching element or transistor.

Moreover, provision is made for that phase of the traction inverter which carries the highest current load among all the phases of the traction inverter to be ascertained. That phase which has a switching transistor whose power loss during the switching period is greater than that of the other transistors is therefore ascertained. The highest current load can be ascertained by sensing or measuring the phase current, or by determining that phase whose duty cycle differs most from 50%. In other words, this can be done by ascertaining that phase which has that transistor whose ON duration is the longest during the switching period. Furthermore, this can be done by ascertaining that phase which has that transistor of all the transistors of the traction inverter whose temperature is highest of all the transistors or whose power loss is highest of all the transistors (during the switching period).

Moreover, that phase of the traction inverter which carries the highest current load among all the phases of the traction inverter can be ascertained by measuring the temperatures of the transistors (individually or in groups), for instance by way of dedicated temperature sensors which are connected to the transistors (individually or in groups) in a heat-transferring manner, or else by detecting signals which the transistors emit and which directly or indirectly reflect the temperature [for instance a temperature-dependent operating variable such as the resistance R_DS(on)].

In addition, that phase of the traction inverter which carries the highest current load among all the phases of the traction inverter can be ascertained by ascertaining the current load profile of the transistors (individually or in groups), for instance starting from control signals or duty cycles of the transistors, and by using a thermal model to map the current load profile of the transistors onto temperatures of the transistors (individually or in groups) which result from the current load profile of the transistors. The temperatures which are ascertained or calculated or predicted by means of the thermal model in such a way are used as a basis for ascertaining that phase of the traction inverter which carries the highest current load among all the phases of the traction inverter. In particular, the thermal model reflects the relationship of current load profile and resulting power loss or the resulting temperature increase. Preferably, the thermal model reflects the thermal capacity of the transistors (and of the components thermally connected thereto, for instance a heat sink) and/or thermal resistances which reflect the thermal connection between the transistors and the components thermally connected thereto (for instance a heat sink) and/or which reflect the thermal connection between the transistors.

For this phase with the highest current load, a duty cycle offset with respect to a duty cycle of 50% is ascertained. The duty cycle offset corresponds to the amount of the difference in the actual duty cycle of this phase minus 50%. The duty cycle offset thus reflects how great the asymmetry of the load on the two transistors of this phase is. For instance, for a duty cycle of 80%, the high-side transistor is switched on and carries current 80% of the period, while the low-side transistor is switched on and generates power loss due to current flow only 20% of the period duration. In this case, the high-side transistor is considerably more loaded and warms up significantly, in particular at low electrical frequencies (i.e. at electrical frequencies below the predefined limit). Provision is made to reduce this load as follows.

The duty cycle offset of this phase is reduced by changing the duty cycle of this phase by a duty cycle change. The duty cycle change causes the duty cycle offset to be reduced or the duty cycle of this phase to be shifted in the direction of a 50% duty cycle. For a target duty cycle of 80%, this can be shifted for example by 10% in the direction of a duty cycle of 50%, so that the result is an actual duty cycle of 70%. This phase is controlled using this actual duty cycle. This reduces the thermal load on that transistor of this phase which has the higher ON time during the switching period from 80% to 70%. As a result, this transistor warms up less from the power loss than without reducing the duty cycle offset.

Finally, the duty cycles of the other phases of the traction inverter are adapted in accordance with the change in the phase with the highest load. Their duty cycles are also changed by the duty cycle change which was carried out for the phase with the highest current load. In the mentioned example in which the duty cycle for the phase with the highest current load was reduced from 80% to 70%, the duty cycle of the other phases is then also reduced by 10%. Thus, in a three-phase system in which the phase with the highest current load has been changed as previously mentioned, the duty cycles of the other phases can be reduced by 10%. This duty cycle change for the phases can be easily implemented and in particular does not require a change in the modulation type. Only the duty cycles are recalculated by simple addition or subtraction steps. The modulation scheme or the modulation type remains unchanged when changing or adapting the duty cycle. For example, the modulation type can be SVPWM before and after changing or adapting. Only parameters such as duty cycle are changed or adapted. The switching times are changed but without changing the modulation scheme or the modulation type.

One aspect is that the duty cycle offset of the phase with the highest current load is reduced with respect to a duty cycle of 50% by reducing, for a target duty cycle of this phase of >50%, the duty cycle of this phase by a reducing duty cycle change to a reduced actual duty cycle of 50% or more. For a target duty cycle of this phase (i.e. the phase with the highest current load of all the phases) of <50%, the duty cycle of this phase is increased by an increasing duty cycle change to an increased actual duty cycle of 50% or less. If the duty cycle of the phase with the highest current load is thus less than 50%, the duty cycle offset is then reduced with respect to 50% by increasing the duty cycle (so that the result is an actual duty cycle greater than the target duty cycle). For a duty cycle of the phase with the highest current load (target duty cycle) of greater than 50%, the duty cycle offset is reduced with respect to 50% by reducing the duty cycle of this phase. This then results in an actual duty cycle smaller than the target duty cycle.

A further aspect is that the duty cycles of the other phases are adapted, namely in the same way as the duty cycle of the phase with the highest current load is changed. The duty cycle of the other phases which do not carry the highest current load is also changed by the duty cycle change, by which the duty cycle offset of the phase with the highest current load is also reduced. The duty cycles of the other phases are adapted by reducing the respective duty cycles of these phases by the reducing duty cycle change if the target duty cycle of the phase with the highest current load is reduced by this duty cycle change. The respective duty cycles of the other phases are increased by the increasing duty cycle change if the target duty cycle of the phase with the highest current load is increased by this duty cycle change. If the duty cycle change for the phase with the highest current load is fixed (in terms of absolute value and sign), this change is then transferred to the other phases. This allows all the phases to be easily adapted without the need for complex calculations. In particular, the adaptation can be performed by shifting the times at which the switching edges occur.

Preferably, the duty cycle change (of all the phases) in absolute value is not greater than the smallest duty cycle of all the phases if the duty cycle change leads to a reduction in the duty cycle. If the duty cycle change is an increase in the duty cycle, then this change in absolute value is then at most equal to the difference of 100% and the greatest duty cycle of all the phases. As a result, the situation is avoided that the phase with the greatest duty cycle is not changed to an (arithmetical) duty cycle of more than 100%. For the phase with the highest current load, a duty cycle change is therefore calculated which is however limited in absolute value by the duty cycles of the other phases in order to thus ensure that the duty cycles of the other phases are not changed arithmetically beyond a duty cycle of 0% or 100%, but rather that for all the phases a duty cycle is obtained which is at the most 100% and at the least 0% and does not arithmetically exceed these values.

The traction inverter can be a three-phase or six-phase inverter, optionally also an inverter with a different number of phases greater than two. Five-phase, seven-phase or nine-phase inverters are thus also conceivable, for example. If the inverter is equipped for a plurality of winding systems and thus comprises a plurality of phase groups which each control one winding system, the method can then be carried out separately for each phase group. In this case, the phase with the highest current load is ascertained for each phase group and the method is carried out for the phases within this group. The groups are thus handled separately from one another according to the method. Alternatively, the inverter may have a plurality of phase groups which are each intended for one winding system but the method is carried out for all the phases of the inverter and thus for all the winding systems or phase groups. In this case, that phase among all the groups which carries the highest current load (or the phase which has the transistor with the highest current load of all the transistors of the inverter) is then ascertained, and all other phases of all the groups are adapted with regard to the duty cycles. As mentioned, the phase with the highest current load can be ascertained by means of temperature measurement or sensing, applying a thermal model of the transistors, ascertaining the transistor with the highest power loss, detecting or measuring the phase current of the respective transistors or by ascertaining that phase which has that transistor whose ON duration is the longest during the switching period.

The traction inverter can be in the form of a high-voltage inverter or can be in the form of an inverter with a nominal voltage of less than 60 V, for instance a 48 V inverter. The inverter (or each phase group) is in the form of a BnC bridge. The variable n corresponds in this case to twice the number of half bridges of the inverter and thus corresponds to the number of high-side and low-side transistors. In this case, a BnC bridge comprises n divided by two half bridges which each have a high-side and a low-side transistor. Other multi-phase pulse inverter architectures can also be used.

As mentioned, a condition for performing the method (i.e. the adaptation of the duty cycles) is preferably that an electrical frequency of the output signal of the traction inverter is below a predefined limit. This corresponds to the condition that the electrical speed of the traction inverter is below a speed limit or that the electric machine connected thereto has a speed below a particular speed limit. In other words, this condition corresponds to a condition according to which a vehicle driven by the electric inverter and the electric machine connected thereto has a speed below a speed limit. The step of determining whether this condition is met can comprise the following sub-steps: ascertaining the electrical speed of the multi-phase output signal of the traction inverter which is emitted by the phases of the traction inverter as three-phase current. Alternatively, a mechanical speed may be measured on an electric machine driven by the inverter. The mechanical speed can be measured as a variable which reflects the electrical speed (optionally multiplied by a factor) or from which this is derived.

Furthermore, the speed is compared with the predefined limit. The condition that an electrical frequency of the output signal is below a predefined limit can be linked to a further condition which must also be met: The further condition can consist in that a power requirement or a torque requirement which is predefined as a target variable for the traction inverter is above a particular limit. Alternatively or in addition, a further condition may consist in that the inverter has a temperature above a temperature limit or that the highest temperature of all the switching elements is above a particular limit. Furthermore, the duty cycle change may depend on one of these variables (power requirement, torque requirement or temperature). The larger one of the above-mentioned variables is, the greater the absolute value of the duty cycle change may turn out. As a result, the method is adapted to suit the present requirements for the drive or for the traction inverter and can also be adapted to suit operating parameters of the traction inverter (in particular the temperature thereof). The limit with which the speed is compared is preferably not greater than 100 Hz, 40 Hz, 10 Hz or 2 Hz. The limit may in particular correspond to a driving speed of 10 km/h, 5 km/h or 2 km/h. In particular, the limit may depend on the temperature of the inverter. The limit can be reduced as the temperature increases. Provision can be made for a first limit for a first temperature to be greater than a second limit of a second temperature which is greater than the first temperature.

Preferably, the duty cycles are changed and adapted while maintaining the PWM modulation type with which the electric machine is operated. In other words, the method makes provision for the traction inverter to be operated by means of one modulation scheme or one modulation type, wherein this modulation type is carried out before reducing or adapting the duty cycles, and this same modulation type is also carried out after the adapting or reducing. For example, the modulation type can be space vector modulation, which is also referred to as Space Vector Pulse Width Modulation (SVPWM). In particular, the steps of reducing or changing and adapting are carried out by changing duty cycles while maintaining the modulation type, in particular by shifting switching times or switching edges by an offset.

Moreover, a traction inverter is described which has a control unit which is designed to control the traction inverter according to the method described here. For this purpose, the control unit can have a device for ascertaining that phase which carries the highest current load. This can be done, for example, by means of a comparator or sorting device which is able to ascertain the highest among the current loads of all the phases (and to identify the associated phase). The control unit can also have a unit for ascertaining the duty cycle offset of this phase with the highest current load with respect to a duty cycle of 50%, wherein this function can be realized, for example, by a differential element.

A device for changing the duty cycles or adapting the duty cycles can additionally be provided in the control unit, wherein this device is configured to temporally offset target switching times, that is to say is configured to temporally adapt the pulse modulation scheme which has the duty cycles (in particular while maintaining the underlying modulation type). In this case, the control unit can have a signal source for the pulse modulation patterns of the individual phases, as well as a unit to change or adapt them according to the method. The control unit can in particular be in the form of a microprocessor or an ASIC, wherein the mentioned unit or method functions are partially or completely realized by software executed on the processor.

Finally, the traction inverter is preferably in the form of a high-voltage power inverter of an electric vehicle drive. Alternatively, the traction inverter is designed for a nominal voltage of less than 60 V, for instance a 48 V traction inverter. A corresponding vehicle drive can thus have the traction inverter, as well as an electric machine which is connected to an output of the vehicle drive, for instance to wheels. The traction inverter is designed in particular for nominal powers greater than 50 or 100 kW. The traction inverter is designed in particular for operating voltages of at least 200, 400 or 800 V; in other embodiments for nominal or operating voltages of less than 60 V, for instance 48 V. The traction inverter is also referred to herein as “inverter” for short.

### BRIEF DESCRIPTION OF THE DRAWINGS

The FIGURE serves to provide an exemplary explanation of embodiments of the method described here and of the traction inverter described here.

### DETAILED DESCRIPTION OF EXEMPLARY EMBODIMENTS

The FIGURE illustrates a three-phase pulse modulation pattern which is to be used to further explain the method described here. The temporal profile of three phase voltages UU, UV and UW is illustrated one above another, said phase voltages relating to the same time axis t. Each pulse pattern of the three phases is a square-wave signal which alternates between the voltages U− and U+, wherein U+ arises at the relevant phase when the high-side transistor is switched on (conductive) and the low-side transistor is switched off (non-conductive). In this case, the phase input is connected to the positive supply voltage U+ via the high-side transistor. If the low-side transistor is conductive and the high-side transistor is not, then the corresponding phase output is connected to the negative supply potential U−, and the potential U-arises at the phase output.

A clock period or pulse period TM is illustrated which for better understanding is divided into eight time periods defined by the times t0 to t8. The original signal, i.e. the target pulse pattern, is illustrated by a solid line. It can be seen that the pulse pattern of the voltage UU already has a rising edge at t1, while the rising edges of the voltages UV and UW occur later, namely at the times t2 and t3, respectively. The duty cycle corresponds to the ratio of the durations during which U+ is output to the length of the entire pulse period TM. The duty cycle thus relates to the pulse period TM, which is repeated after t8, optionally with a different duty cycle.

If it is detected that the electrical frequency of the output signal of the traction inverter (i.e. the resulting speed of the electric field generated by the output signal in the connected electric machine) is below a predefined limit, that phase which carries the highest current load among all the phases, or that phase which has the transistor with the highest current load, is ascertained. In this example, this is intended be the first phase BP, i.e. the phase which outputs the voltage UU. The phase BP with the highest current load is thus labeled with the double arrow and the reference sign BP.

In the example illustrated, BP is intended to be the phase with the highest current load, which was ascertained, for example, by integrating or summing up the current loads of all the transistors for a particular time period (for instance over a window of 10 ms, 50 ms, 200 ms, 500 ms, 1 s, 5 s, 10 s or more). The transistor and thus the phase with the highest current load can also be ascertained on the basis of the temperatures of the transistors. A duty cycle offset O of this phase BP with respect to a duty cycle of 50% is ascertained. This is illustrated by the duration O between the first switching edge of the phase BP at time t1 and the time t2, which marks the time of occurrence of a switching edge as it would occur at a duty cycle of 50%.

A duty cycle of 50% arises for switching edges which are at t2 and at t6 (corresponding to the pulse pattern of the voltage UV). In the example illustrated, this corresponds to two times an eighth of the entire pulse duration TM and is visualized by the temporal distance O between the times t1 and t2. A duty cycle of 50% would mean an edge at t2, wherein the illustrated phase with the highest current load BP already exhibits a switching edge at time t1 and, symmetrically with respect to the time t4 (=the middle of the illustrated period), at time t7.

Thus, in the phase BP, six time periods (t1 to t7) fall to a high level, while only two time periods (t0 to t1 and t7 to t8) fall to a low level. This thus results in a duty cycle of six (number of time periods with high level) to eight (number of time periods of the entire period TM). In other words, the duty cycle of the voltage U or of the phase with the highest current load (reference sign BP) is 75%.

In this example, the phases of the voltages UV and UW, i.e. the second and third phases, are not intended to be the phase with the highest current load and thus form the further phases. The associated duty cycles are 50% and 25%, respectively. This relates to the target pulse pattern which is illustrated by a solid line, i.e. a non-reduced or adapted duty cycle.

After the first phase has been ascertained as the phase with the highest current load (reference sign BP), and the duty cycle offset of this phase (BP or phase of the voltage U) with respect to 50% has been ascertained, this duty cycle offset (i.e. the deviation with respect to 50%) of this phase is changed by a duty cycle change D. This results in a pulse pattern with a changed or adapted duty cycle, which is illustrated by a dashed line. In the FIGURE, in the phase with the highest current load BP, the duty cycle offset is greater than 50% and so the duty cycle is changed by reducing by the duty cycle change. In other words, the switching time is shifted in the direction of a 50% duty cycle. The rising edge is thus delayed, and the falling edge in the phase with the highest current load is moved forward by the change D. Since the switching times are closely linked to the duty cycles, the same reference sign D is used.

The second and third phases (the phases of the voltages UV and UW) are also changed in the same way by delaying the rising edge and moving the falling edge forward in time, in order to thus also change the duty cycles for the second and third phases, i.e. for the further phases, in such a way as was changed for the phase with the highest current load BP.

For all three phases, the duration of the high level is thus shortened in favor of the duration of the low level.

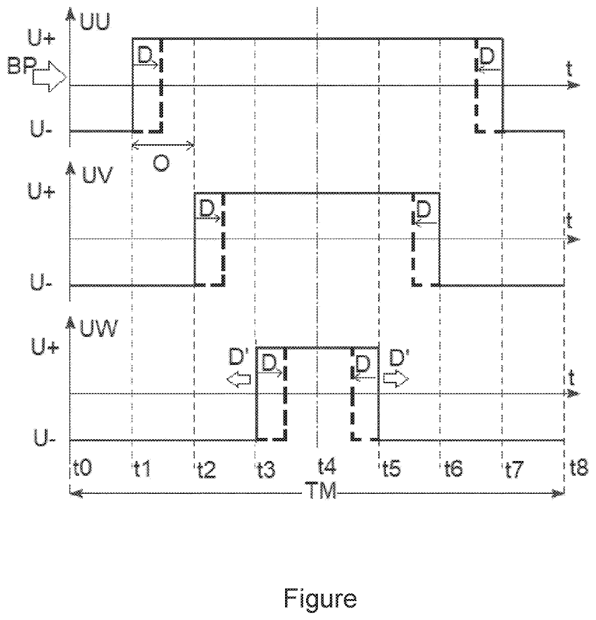

The duty cycle change D illustrated is a reducing duty cycle change which reduces a target duty cycle of >50% (namely 75%) to a reduced actual duty cycle (in FIG. 1 approx. 62%). In this case, the actual duty cycle is 50% or more but is less than 50% away from the original target duty cycle. By reducing the time of the high level in the phase with the highest current load BP (which after the duty cycle change D is less than the duration from t1 to t7), the high-side transistor of the phase with the highest current load BP is relieved since it has to carry current and thus generates power loss for a shorter duration per period.

For example, if there is a low duty cycle of considerably below 50%, then a low-side transistor can have a high thermal load, and in particular have the highest current load of all the transistors. For this case, i.e. for a target duty cycle of <50%, an increasing duty cycle change D′ is provided which reduces the ON time of the low-side transistor and increases the ON time of the high-side transistor. The case of an increasing duty cycle change is thus illustrated symbolically with D′ (for better clarity only for the third phase, wherein this change is also to be carried out for all phases). The increasing duty cycle change D′ is illustrated by a double arrow; the decreasing duty cycle change D is illustrated by a single arrow.

1. A method for controlling a multi-phase traction inverter, the method comprising:
determining whether the condition that an electrical frequency of the output signal of the traction inverter is below a predefined limit is met;
if the condition is met:
ascertaining that phase of the traction inverter which carries the highest current load among all the phases of the traction inverter;
ascertaining a duty cycle offset of this phase with respect to a duty cycle of 50%;
reducing the duty cycle offset of this phase by changing the duty cycle of this phase by a duty cycle change; and
adapting the duty cycles of the other phases of the traction inverter by also changing their duty cycles by the duty cycle change.

2. The method as claimed in claim 1, wherein the duty cycle offset of the phase with the highest current load is reduced with respect to a duty cycle of 50% by reducing, for a target duty cycle of this phase of greater than 50%, the duty cycle of this phase by a reducing duty cycle change to a reduced actual duty cycle of 50% or more, and by increasing, for a target duty cycle of this phase of less than 50%, the duty cycle of this phase by an increasing duty cycle change to an increased actual duty cycle of 50% or less.

3. The method as claimed in claim 2, wherein the duty cycles of the other phases are adapted by reducing the respective duty cycles of these phases by the reducing duty cycle change if the target duty cycle of the phase with the highest current load is reduced by this duty cycle change, and by increasing the respective duty cycles of the other phases by the increasing duty cycle change if the target duty cycle of the phase with the highest current load is increased by this duty cycle change.

4. The method as claimed in claim 1, wherein the traction inverter that is controlled is a three-phase or six-phase inverter in the form of a BnC bridge, wherein n is twice the number of half bridges of the inverter.

5. The method as claimed in claim 1, wherein the determination of whether the condition is met comprises:
ascertaining the electrical speed of the multi-phase output signal of the traction inverter which is emitted by the phases of the traction inverter as three-phase current; or measuring a mechanical speed of an electric machine connected to the inverter as a variable which reflects the electrical speed or from which this is derived, and
comparing the speed with the predefined limit.

6. The method as claimed in claim 5, wherein the limit is not greater than 100 Hz, 40 Hz, 10 Hz or 2 Hz.

7. The method as claimed in claim 5, wherein the limit depends on the temperature of the inverter and a first limit for a first temperature is greater than a second limit for a second temperature which is higher than the first temperature.

8. The method as claimed in claim 1, wherein the duty cycles are changed and adapted while maintaining the PWM modulation type.

9. A traction inverter having a control unit which is designed to control the traction inverter according to the method as claimed in claim 1.

10. The traction inverter as claimed in claim 9, wherein said traction inverter is in the form of a high-voltage power inverter of an electric vehicle drive or is in the form of a power inverter of an electric vehicle drive and has a nominal voltage of less than 60 V.

11. The method as claimed in claim 6, wherein the limit depends on the temperature of the inverter and a first limit for a first temperature is greater than a second limit for a second temperature which is higher than the first temperature.

12. The method as claimed in claim 2, wherein the traction inverter that is controlled is a three-phase or six-phase inverter in the form of a BnC bridge, wherein n is twice the number of half bridges of the inverter.

13. The method as claimed in claim 3, wherein the traction inverter that is controlled is a three-phase or six-phase inverter in the form of a BnC bridge, wherein n is twice the number of half bridges of the inverter.

14. The method as claimed in claim 2, wherein the determination of whether the condition is met comprises:
ascertaining the electrical speed of the multi-phase output signal of the traction inverter which is emitted by the phases of the traction inverter as three-phase current; or measuring a mechanical speed of an electric machine connected to the inverter as a variable which reflects the electrical speed or from which this is derived, and
comparing the speed with the predefined limit.

15. The method as claimed in claim 3, wherein the determination of whether the condition is met comprises:
ascertaining the electrical speed of the multi-phase output signal of the traction inverter which is emitted by the phases of the traction inverter as three-phase current; or measuring a mechanical speed of an electric machine connected to the inverter as a variable which reflects the electrical speed or from which this is derived, and
comparing the speed with the predefined limit.
